(19) United States
(12) Patent Application Publication
(10) Pub. No.: US 2004/0203635 A1
(43) Pub. Date: Oct. 14, 2004

(54) Method of transferring data during interactive teaching procedure

(76) Inventors: Say-Yee Wen, Taipei (TW); Shih-Li Wen, Taipei (TW)

Correspondence Address: BIRCH STEWART KOLASCH & BIRCH, PO BOX 747, FALLS CHURCH, VA, 22040-0747, US

(21) Appl. No.: 10/127,719

(22) Filed: Apr. 23, 2002

(51) Int. Cl. H04M 3/42

(52) U.S. Cl. 455/414.1; 455/66.1

(57) ABSTRACT

This specification discloses a method of transferring data during an interactive teaching procedure. This method allows a user to provide supplementary data during an interactive teaching procedure. The supplementary data are transferred to the information processing device of another user while teaching.

### BACKGROUND OF THE INVENTION

1. Field of Invention

The invention relates to a method of transferring data during an interactive teaching procedure and, in particular, to an interactive teaching delivery method used in information processing devices.

2. Related Art

The conventional teaching method uses data printed in books or paper as the teaching materials. For students, however, these heavy paper materials are burdens to the bodies. In addition to the physical pressure brought by the teaching materials, these materials have fixed contents that may not be enough to cover all that a student need to learn or sufficiently clear in presenting the relevant materials. Therefore, teachers play an important role in explaining the information contained in the materials. A usual way used by the teachers is to supply the students with more papers or notes. This then adds to students more burdens.

For such problems, some of the prior arts adopt the solution of totally computerization. This is because the computers have large memory capacities for storing a huge amount of information or messages. With the advantage of the network, students can receive more information for comprehending the learning materials. In addition, the students do not have to carry heavy learning materials. Thus, this method is said to be the ideal teaching and learning model. Although modern personal computers are much more compact and cheaper than traditional ones, building a complete computer network and its resources still occupies a large portion of the education budget for the school. As these resources are kept at school and cannot be carried away, it is hard for the students to review the learning materials.

### SUMMARY OF THE INVENTION

In observation of the foregoing problems in the prior art, it is an objective of the invention to provide a method of transferring data during an interactive teaching procedure. Using such properties as lightness, compactness, large data storage, and wireless network connection associated with, for example, the PDA (Personal Digital Assistant), the mobile communication devices and the portable computers, a new interactive teaching environment is provided to achieve the goals of providing abundant information, allowing users to understand the contents, and making easy for users to memorize learning materials.

The interactive learning procedure is mainly comprised of learning material remarks before the interactive teaching and learning material explanation during the interactive teaching. In the process of material remarks, a user (teacher) can supplement and store more teaching materials using an information processing device. When explaining the materials, the supplemented remarks can be readily displayed in front of another user (student) by using the transmission and display functions of the information processing device. The student can thus rapidly understand the contents of the materials and more easily memorize the information.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of different ways to obtain data;

FIG. 2 is a flowchart for commentaries establishment;

FIG. 3 is a flowchart for commentaries transmission;

FIG. 4 is a flowchart for commentaries reception and storage;

FIG. 5-A shows a marked block 1 in an embodiment of the invention;

FIG. 5-B shows the commentary 1 for the marked block in FIG. 5-A;

FIG. 6-A shows a newly created emphasis according to the embodiment of the invention;

FIG. 6-B shows the commentary for the newly created emphasis in FIG. 6-A;

FIG. 7-A shows a commentary index of the invention; and

FIG. 7-B shows that one of the commentaries is selected from FIG. 7-A.

### DETAILED DESCRIPTION OF THE INVENTION

According to the invention, the method of transferring data during an interactive teaching procedure is a method for transferring remarks and notes supplemented by a user to the information processing device of another user during an interactive teaching procedure. In this method, the information processing device used by the users can be PDA (Personal Digital Assistant), mobile communication devices, or portable computers. This method is mainly applied in teaching and learning. Since such data are provided for students to more easily or fully understand the learning materials, they often form the crucial part of the learning during the teaching procedure.

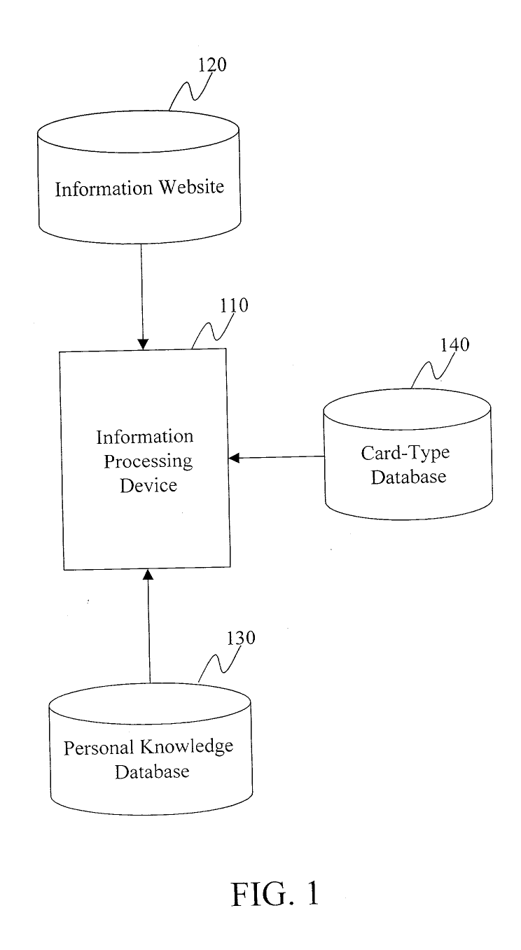

When these teaching materials are presented in digital forms, they can be stored in an information processing device. How the knowledge data stored in the information processing device can be obtained or provided is demonstrated in FIG. 1. As shown in the drawing, the information can be obtained from an information website 120, a personal knowledge database 130, and a Card-Type database 140.

The information from the information website 120 refers to data that can be downloaded to a personal information processing device 110 from any website on a network. The information from the personal knowledge database 130 refers to personal research results that are written and stored on a personal computer. Through the connection ports of the computer and the information processing device 110, one can download the personal knowledge to the information processing device 110. The information from the card database 140 refers to a card-type e-book or a card-type memory base developed and made by the information processing device agent or manufacturer for the information processing device 110. One thus can have another data source by using the card memory reading module built inside the information processing device 110.

Besides presenting materials, providing additional notes during the teaching procedure is sometimes more important because they may contain essences extracted by learned persons from the standard materials. With the help of the information processing device 110, a user can readily transmit supplementary information to another user. Thanks to the tremendous advances in technologies, common information processing devices already have the ability to present e-books in animations. Thus, users can make more vivid and comprehensible supplementary materials.

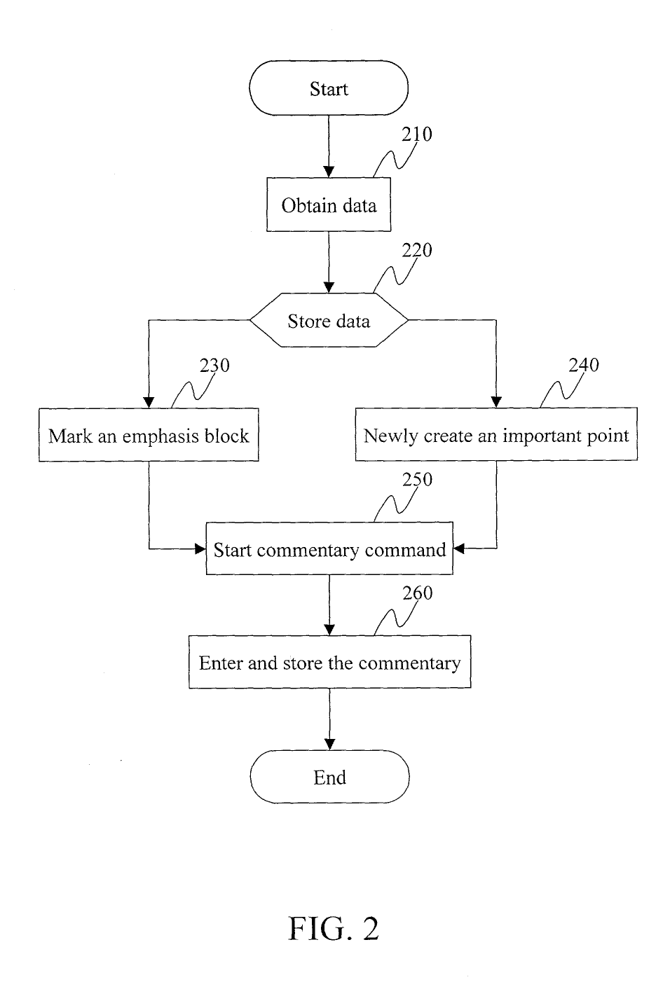

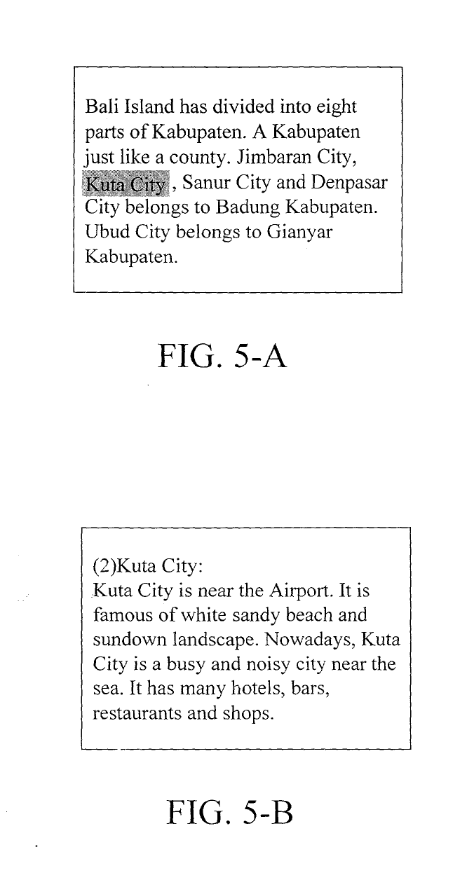

Please refer to FIG. 2 for an explanation of how to make supplementary data. First, a user has to obtain data from sources mentioned before (step 210). After the data are obtained, they have to be stored in an information processing device 110 for making comments or remarks (step 220). Afterwards, the user can mark or emphasize important words or phrases, sections, and paragraphs (such as the emphasis block in FIG. 5-A) in the data (step 230) in order to append the data with commentaries. Of course, after marking the emphasis blocks (step 230), a comment command has to be started (step 250) for editing and appending commentaries (such as the comments in FIG. 5-B). The commentaries appended by the user can be normal text information or multimedia information presented in animations, pictures or video clips. After entering and storing the commentaries (step 260), the user completes the commentary data input procedure. For commentaries unrelated to the original teaching materials, the user has to choose a create-new command to create new notes (step 240) before he or she can start the comment command (step 250). Afterwards, the user can then edit, enter and save the commentaries (step 260) as mentioned before.

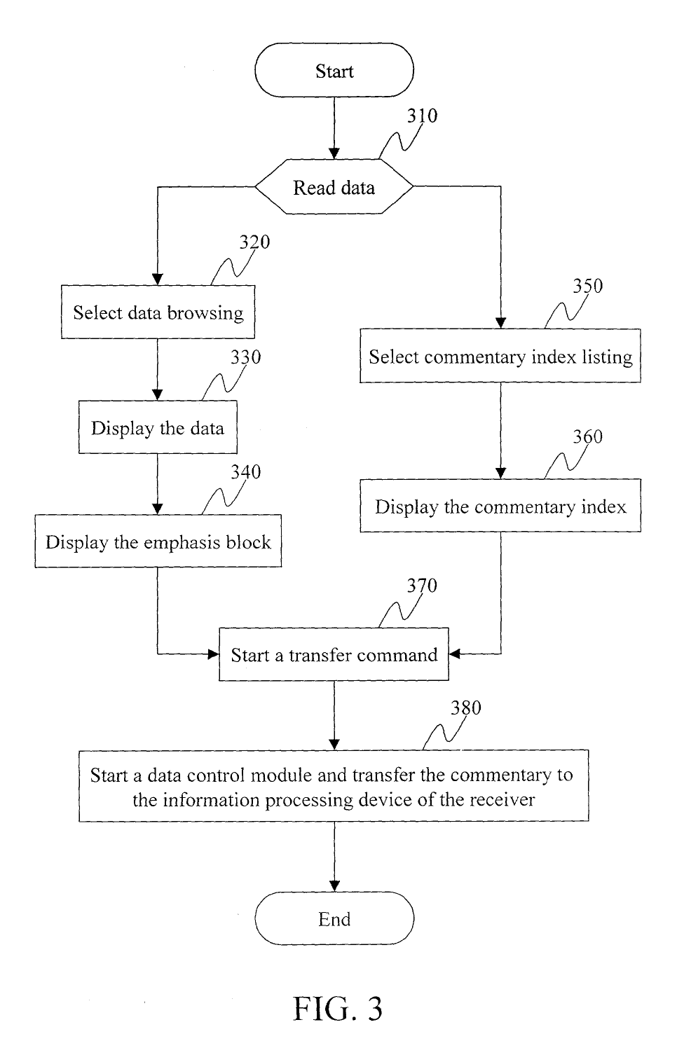

After finishing preliminary commentaries editing, an important part later on is in teaching. The point here is in the information transfer. FIG. 3 demonstrates how a user on the sending end (sender) sends his commentaries to another user on the receiving end (receiver).

First, each user has to use his or her information processing device 110 to read data (step 310). These data are obtained from the above-mentioned information website 120 and card-type database 140. All users use the same method to obtain information. As to the data from a personal knowledge database 130, they are provided by a sender. Therefore, the receiver can obtain the data from a specific website where the sender uploads his database. Alternatively, the sender can also send his data to the personal computer of the receiver through the network. Yet, another method is that the sender stores his data in memory cards of the information processing device 110, which are then distributed to other users. Finally, one can also build direct connection between the information processing devices 110 on the sending and receiving ends.

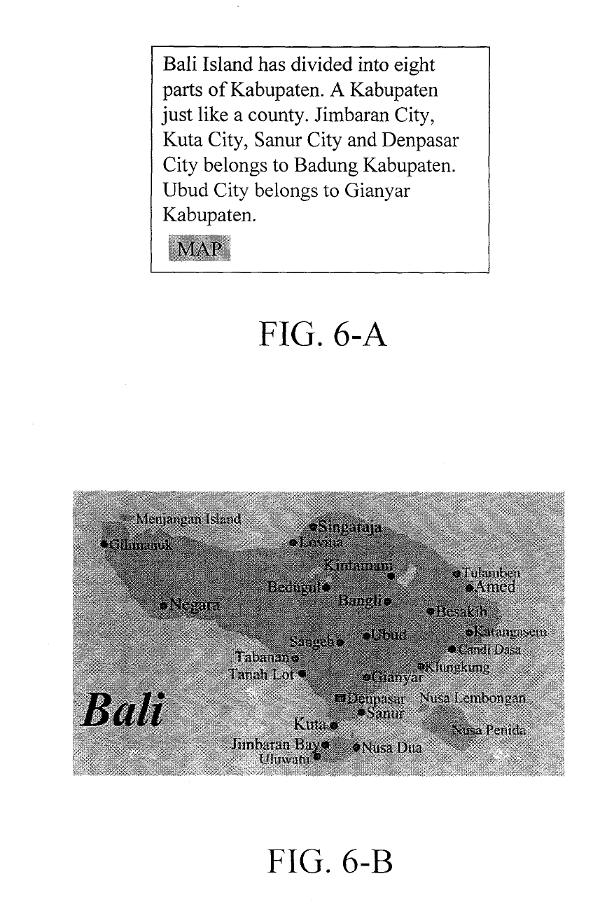

After the receiver obtains the data, the sender has two choices for the sender to transmit the commentaries at the same time of explaining data. Both of the methods use wireless transfer protocols. The first one is that when the data browsing is selected (step 320), the system displays the data (step 330). Once the teacher explains a marked section, the emphasis block is selected and highlighted (step 340) (such as the emphasis blocks in FIG. 5-A and the newly created emphasis in FIG. 6-A). The sender can use a transfer key to start a transfer command (step 370) and send the commentaries to the information processing device 110 of the receiver. At the same time the transfer command is initiated (step 370), the system starts a data control module and transfers the commentaries to the information processing device 110 of the receiver (step 380). This completes the transfer action.

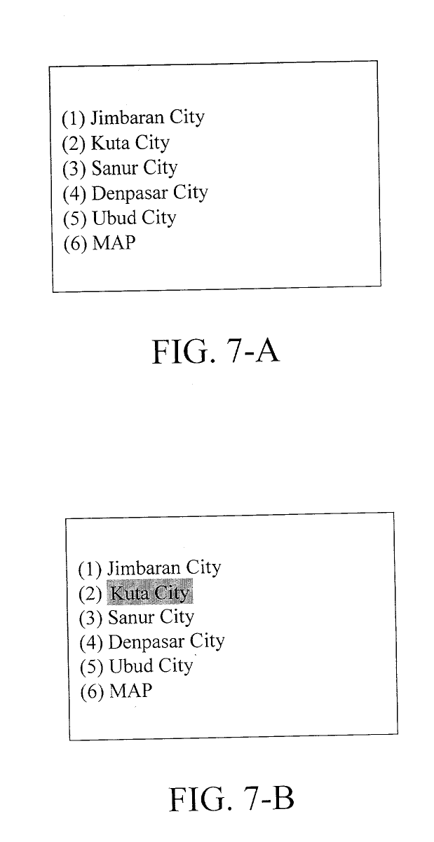

The other method is that when the sender selects commentary index (step 350), as the one shown in FIG. 7-A, the system only displays the commentary index (step 360) for the sender to choose and send. After the sender selects the desired commentary to transfer, as the one shown in FIG. 7-B, the start transfer command is initiated through the transfer key (step 370) to transfer data. Before transmitting the commentary, the system first starts the data control module and transfers the commentary to the information processing device 110 of the receiver (step 380) to complete the transfer action. The above-mentioned data control module is used to control the correct data transmission to a specific information processing device group, preventing other unrelated group or individuals from being disturbed.

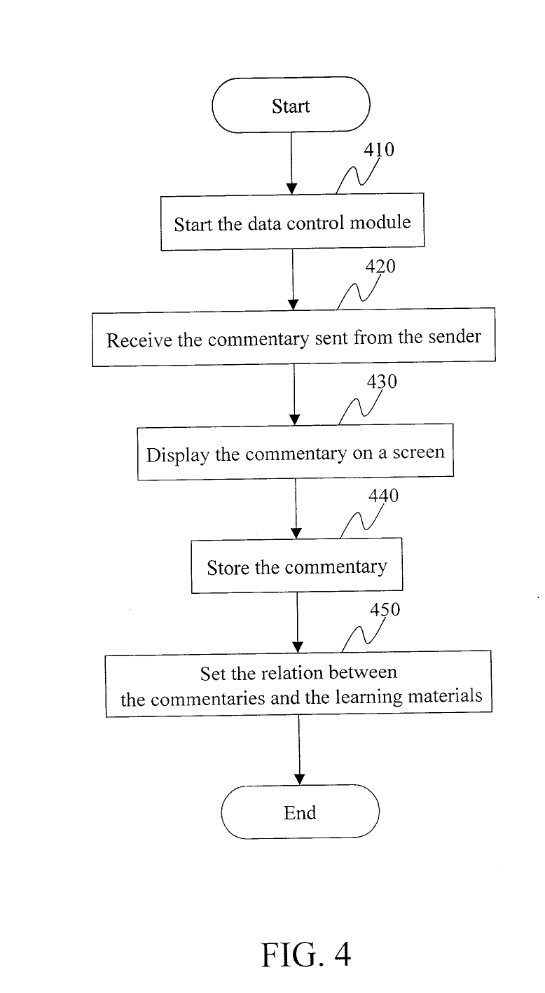

Please refer to FIG. 4 for the receiving and storage of the commentaries. First, the receiver starts the data control module in class (step 410) for receiving data or commentaries from the sender at any time. After receiving the commentaries provided by the sender (step 420), the information processing device 110 immediately displays the commentaries on the screen (step 430), such as the ones shown in FIGS. 5-B and 6-B. The receiver can select to store or delete the received information. If the receiver selects to store the commentaries (step 440), the system asks the receiver to set the association of the commentaries at the same time the save key is pressed. At this moment, the receiver can relate the commentaries and the materials (step 450), indicating which part of the learning materials is referred to by a particular commentary.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A data transfer method during an interactive teaching procedure for a user to edit commentaries, the method comprising the steps of:
storing a data on an information processing device;
marking a marked block on the data;
starting a comment command for the marked block; and
entering and storing commentaries following the comment command.

2. The method of claim 1, wherein the information processing device is selected from the group consisting of a PDA (Personal Digital Assistant), a mobile communication device, and a portable computer.

3. The method of claim 1, wherein the data are selected from the group consisting of an information website, a personal knowledge database, and a card-type database.

4. The method of claim 1, wherein the data providing method for downloading the data to a PDA is selected from the group consisting of using a wireless transfer protocol, using a personal computer, and using a card-type database.

5. The method of claim 1 further comprising the steps of:
selecting a newly create command to start a comment command; and
entering and storing commentaries following the comment command.

6. A data transfer method during an interactive teaching procedure for sending commentaries from the information processing device of a sender to the information processing device of a receiver, the method comprising the steps of:
using an information processing device to read a data;
selecting a data browsing item and displaying the data;
displaying a marked block in the data;
selecting the marked block to start a transfer command; and
starting a data control module according to the transfer command and transferring the commentaries to the information processing device of the receiver.

7. The method of claim 6, wherein the information processing device is selected from the group consisting of a PDA (Personal Digital Assistant), a mobile communication device, and a portable computer.

8. The method of claim 6, wherein the data are selected from the group consisting of an information website, a personal knowledge database, and a card-type database.

9. The method of claim 6, wherein the commentaries are stored in a place selected from the group consisting of a personal knowledge database and a card-type database.

10. The method of claim 6, wherein the data providing method for downloading the data to a PDA is selected from the group consisting of using a wireless transfer protocol, using a personal computer, and using a card-type database.

11. The method of claim 6, wherein the commentaries are transmitted to a PDA using a wireless transfer protocol.

12. The method of claim 6, wherein the data control module controls the transmissions of data to specific information processing devices.

13. The method of claim 6 further comprising the steps of:
choosing a commentary index selection and displaying a commentary;
choosing the commentary to start a transfer command; and
starting a data control module following the transfer command and transferring the commentary to another information processing device.

14. A data transfer method during an interactive teaching procedure applied to an information processing device for storing commentaries at a receiving end, which comprises the steps of:
starting a data control module;
receiving and displaying a commentary of a particular data;
executing a storage command and providing an relational command; and
setting the relation between the commentary and the data according to the relational command.

15. The method of claim 14, wherein the information processing device is selected from the group consisting of a PDA (Personal Digital Assistant), a mobile communication device, and a portable computer.

16. The method of claim 14, wherein the data are selected from the group consisting of an information website, a personal knowledge database, and a card-type database.

17. The method of claim 14, wherein the commentaries are stored in a place selected from the group consisting of a personal knowledge database and a card-type database.

18. The method of claim 14, wherein the data providing method for downloading the data to a PDA is selected from the group consisting of using a wireless transfer protocol, using a personal computer, and using a card-type database.

19. The method of claim 14, wherein the commentaries are transmitted to a PDA using a wireless transfer protocol.

20. The method of claim 14, wherein the data control module controls the transmissions of data to specific information processing devices.
